(19) United States
(12) Patent Application Publication
(10) Pub. No.: US 2014/0027586 A1
(43) Pub. Date: Jan. 30, 2014

(54) Quick Connect-Disconnect Dual Dovetail Plate Mounting System

(71) Applicants: Michael H. Ottley, Winchester, TN (US); Ronald L. King, Normandy, TN (US)

(72) Inventors: Michael H. Ottley, Winchester, TN (US); Ronald L. King, Normandy, TN (US)

(21) Appl. No.: 13/558,416

(22) Filed: Jul. 26, 2012

(51) Int. Cl. B64D 47/00

(52) U.S. Cl. 248/201

(57) ABSTRACT

A quick connect-disconnect mount assembly is provided having
a first dove tailed mounting bracket;
a second dove tailed mounting bracket;
wherein said first and second mounting bracket is constructed and arranged with male/female dove tail channels and further whereby said brackets are secured one to another using a single securing bolt that provides tension to effectuate said securing.

### BACKGROUND OF THE INVENTION

### Field of the Invention

It is often desired to securely fasten one component to another in a manner that provides a secure connected relationship that is able to withstand various external forces. Those that operate aircraft face a special challenge due to a plurality of wind and vibrational forces that can act upon an externally mounted device. Additionally, although securing might be effectuated by permanent mountings, these are not suitable when it is desired to quickly remove and change externally mounted components. It is desired to find a system by which externally mounted components are secured efficiently to withstand various wind and vibrational forces of an aircraft and further whereby said externally mounted component can be quickly and easily removed and/or changed for another component. The present invention has addressed these difficulties by providing an article that quickly and easily secures onto an aircraft and provides a removable portion whereby an externally mounted article can be quickly and easily changed.

### SUMMARY OF THE INVENTION

The present invention is a mounting system whereby a quick connect-disconnect mount assembly comprising:
a first dove tailed mounting bracket;
a second dove tailed mounting bracket;
   wherein said first and second mounting bracket is constructed and arranged with male/female dove tail channels and further whereby said brackets are secured one to another using a single securing bolt that provides tension to effectuate said securing is used.

The assembly has a first mounting plate is constructed and arranged to secure to a mounting arm and a said second mounting plate is constructed and arranged to hold a desired component and to slidibly attach to said first mount plate.

The assembly of claim 1 comprising an assembled configuration of each of said mounting plates and a disassembled configuration whereby said mounting plates are separated.

### BRIEF DESCRIPTION OF THE SEVERAL VIEWS OF THE DRAWING

FIG. 1 is a side view showing the quick disconnect component mount assembly of the present invention.

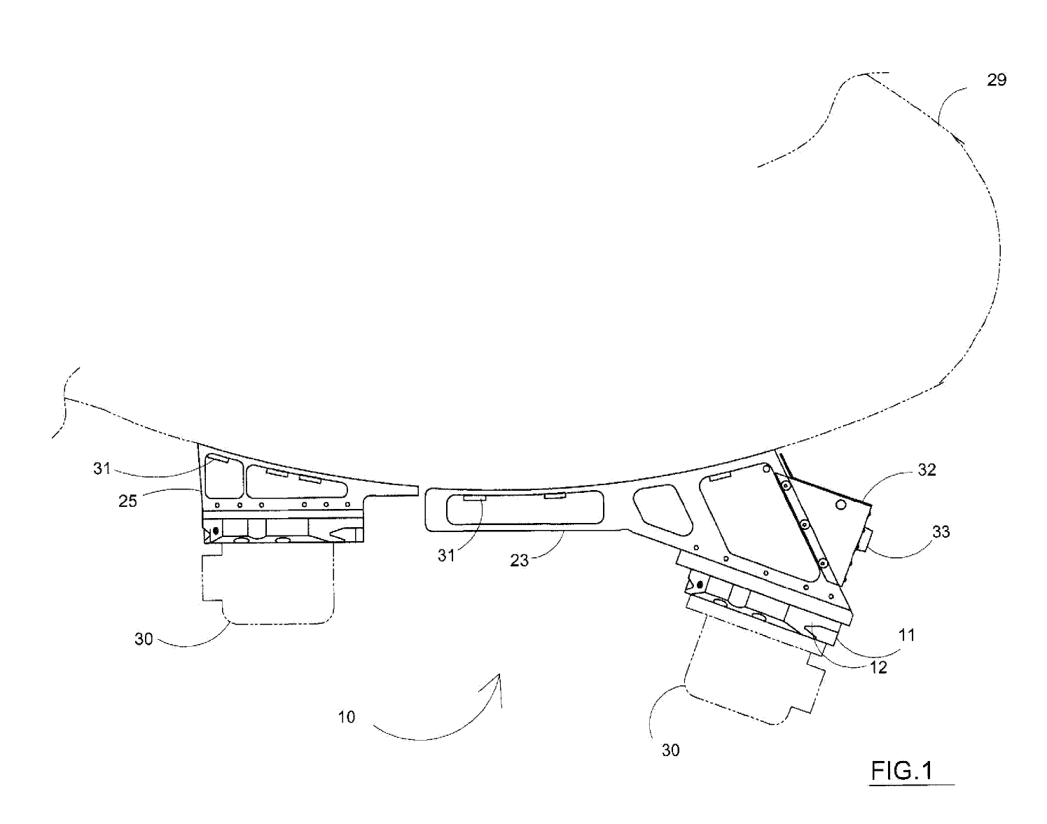

FIG. 2 is an exploded isometric of the quick disconnect mount of the present invention.

FIG. 3 is a partially exploded plan view of the quick disconnect mount of the present invention.

FIG. 4 is a plan view of the assembled quick disconnect mount of the present invention.

### DETAILED DESCRIPTION OF THE PREFERRED EMBODIMENT

In a preferred embodiment the assembly 10 is constructed and arranged to secure to an airframe 29 of an aircraft. The aircraft can be an airplane, helicopter, dirigible, and the like. It is contemplated that a component 30 is easily attached and subsequently detached using assembly 10 of the present invention. Component 30 typically is some type of camera or photographic device. However, component 30 is not limited to such devices. The components are constructed and arranged with a male mount plate 11 constructed and arranged to interact with a female mount plate 12. Male mount plate 11 is constructed and arranged with a pair of dovetail groove surface 19 along each of two longitudinal sides on female mount plate 11. Male mount plate 12 is constructed and arranged with corresponding dovetail groove surfaces 20 along each of two longitudinal sides corresponding to and constructed and arranged to interact with dovetail surface groove 19 of female mount plate 11.

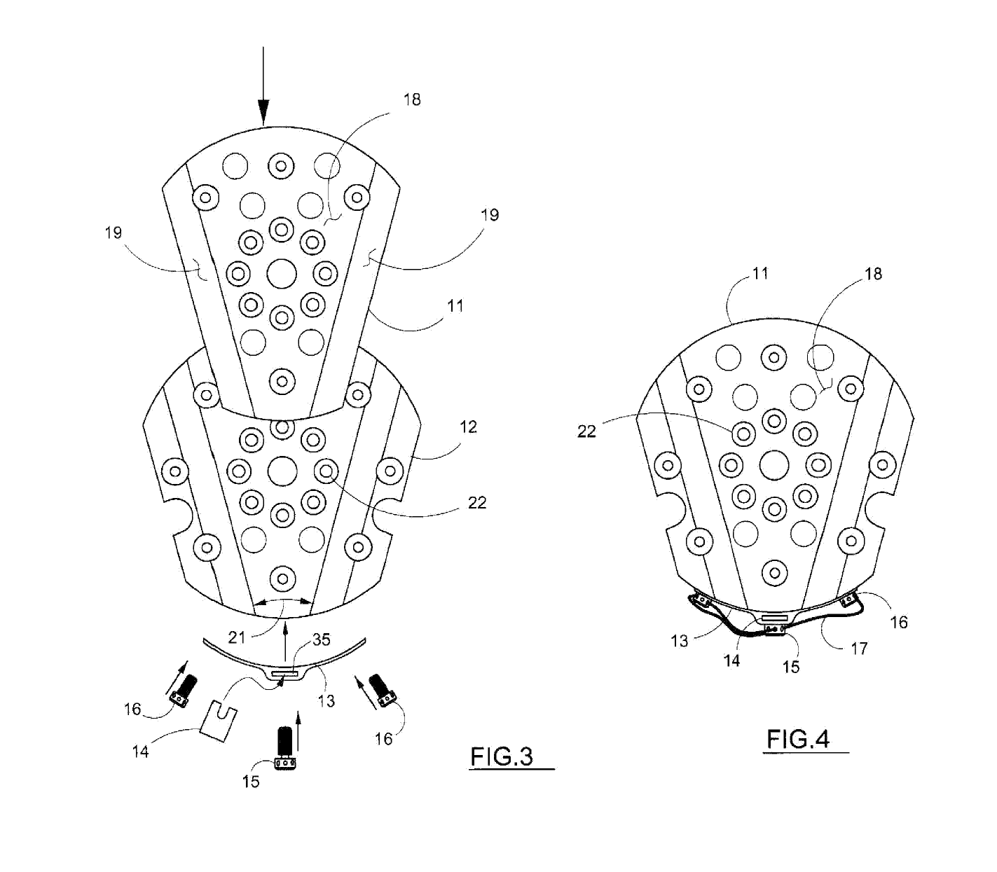

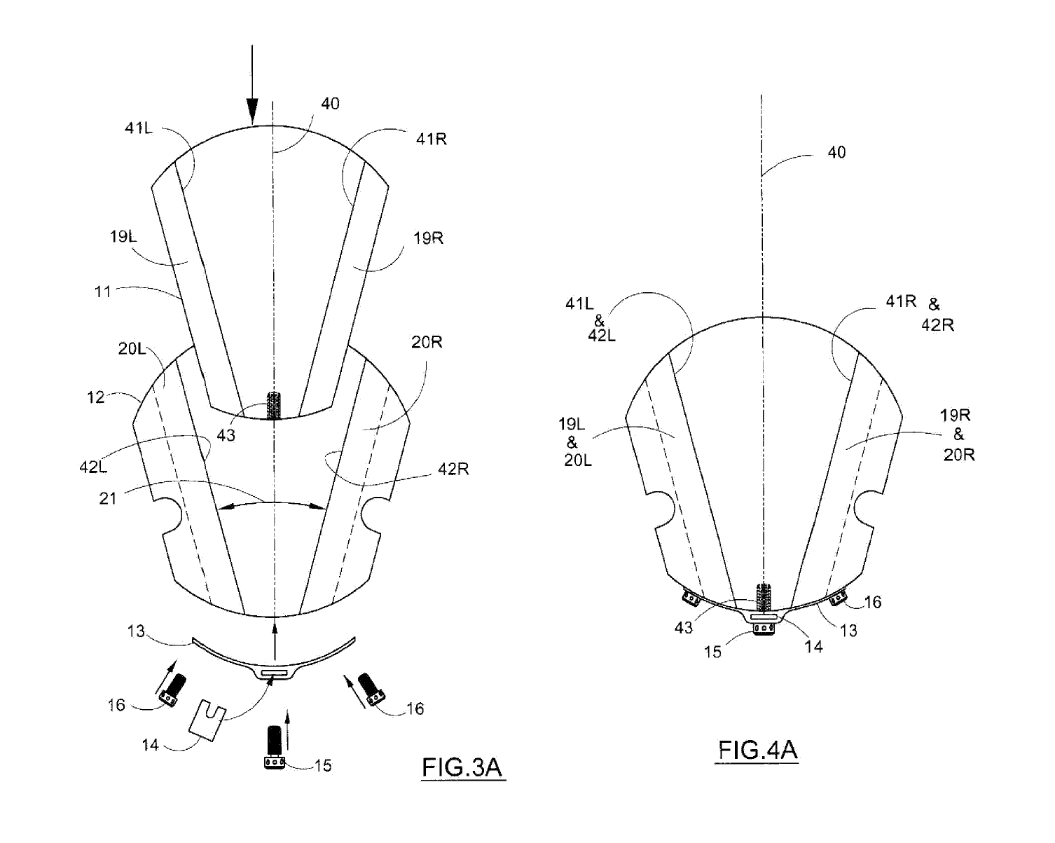

As best demonstrated in FIG. 3, female mount plate 11 is constructed and arranged such that it slidibly attaches along corresponding dove tail surfaces to the configuration demonstrated in FIG. 4.

Bracket 12 is constructed and arranged to mount on rear mount arm 25 and rear mount 25 subsequently is constructed and arranged to attach at attaching point 31 to air frame 29. Article 30 is mounted on female mount plate 11 such that the removal of article 30 being a typical component is quickly and efficiently accomplished by separation of female mount plate 11 from male mount plate 12. The system can also include a second bracket assembly whereby forward mount arm 23 holds the component 30.

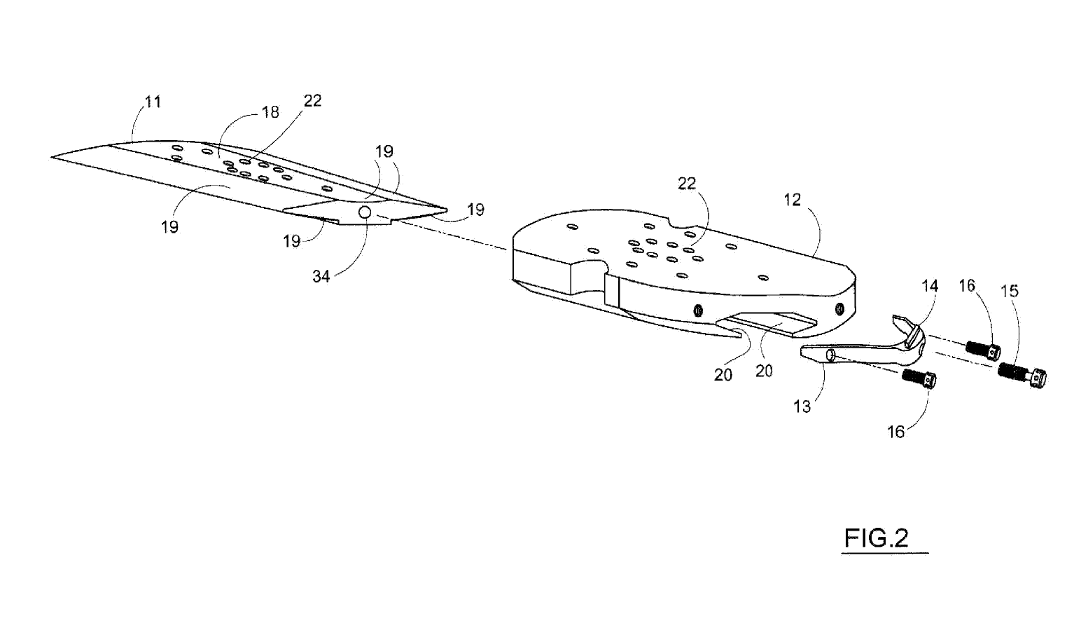

As best seen in FIG. 2, the quick removal procedure involves removal of nose bolt 15. Nose bolt bracket 13 and a nose bolt bracket key 14 are secured onto male mount bracket 12 using nose bolt 15. Furthermore female mount plate 11 when positioned within male mount plate 12 is constructed and arranged such that nose bolt 15 secures into female mount plate 11 as indicated by directional arrow in FIG. 2. To ensure attachment, a screw retaining wire 17 is passed through a wire-receiving cavity each of nose bolt 15 and nose bolt bracket mounting screws 16. Each of nose bolt bracket mounting screws 16 secures nose bolt bracket 13 to threaded orifice 34 of female plate 11.

Thus a typical component 30 mounted on female mount plate 11 is slidably detached by the single action of removing nose bolt 15. Thus, in combination it can be seen male mount plate 12 is attached to forward mount 23. A desired component 30 is attached to female mount plate 11. When female mount plate 11 is slid into position such that it mates with male mount plate 12, female mount plate 11 is secured using the aforementioned nose bolt 15. In order to quickly remove and/or change desired component 30 to a different desired component, nose bolt 15 is removed, female mount plate 11 is slidably removed from male mount plate 12 a second female mount plate 11 is slid into position and secured into place with male mount plate 12 by replacing nose bolt 15. It has been discovered that the matching dove tail configurations provides increased stability and strength to mounting components of the present invention due to an increase of surface area contact. Furthermore, tapering the dove tails maximizes the surface contact. Additionally, the mounting of the present invention is advantageous because nose bolt 15 is utilized as a tension bolt rather than in shear.

Shear force, as is known, is defined as the component of stress coplanar with a material cross section. Shear stress, or shear force arises from the force vector component parallel to the cross section. Tension force is measured along the direction of the force. The arrangement of slidable attachment, and mounting bolt applied in a generally coplanar direction with the slidable attachment, imparts a closure system where tension force secures each of plates 11 and 12 in position. In this arrangement, tension force is a force less than shear force or other forces that would be required in a different arrangement.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A quick connect-disconnect mount assembly comprising:
a first dove tailed mounting bracket;
a second dove tailed mounting bracket;
wherein said first and second mounting bracket is constructed and arranged with male/female dove tail channels and further whereby said brackets are secured one to another using a single securing bolt that provides tension to effectuate said securing.

2. The assembly of claim 1 wherein said first mounting plate is constructed and arranged to secure to a mounting arm.

3. The assembly of claim 1 wherein said second mounting plate is constructed and arranged to hold a desired component and to slidibly attach to said first mount plate.

4. The assembly of claim 1 comprising an assembled configuration of each of said mounting plates and a disassembled configuration whereby said mounting plates are separated.

5. The assembly of claim 1 wherein said securing bolt is constructed and arranged to provide attachment utilizing tension when said plates are secured one to another wherein said plates are connected in a substantially coplanar configuration.
